(19) United States
(12) Patent Application Publication
(10) Pub. No.: US 2026/0197273 A1
(43) Pub. Date: Jul. 9, 2026

(54) METHOD FOR DATA TRANSMISSION, AND COMMUNICATION SYSTEM

(71) Applicant: CHINA SATELLITE NETWORK INNOVATION CO., LTD, Beijing (CN)

(72) Inventors: Junshuai SUN, Beijing (CN); Yingying Wang, Beijing (CN); Chunlei Niu, Beijing (CN); Rui Teng, Beijing (CN); Xuekun Hao, Beijing (CN)

(21) Appl. No.: 19/539,787

(22) Filed: Feb. 13, 2026

Related U.S. Application Data
(63) Continuation of application No. PCT/CN2025/095209, filed on May 15, 2025.

(30) Foreign Application Priority Data
Nov. 21, 2024 (CN) 202411677296.0

(51) Int. Cl. H04L 45/74

(52) U.S. Cl. CPC H04L 45/74

(57) ABSTRACT

A method for data transmission, performed by a communication system including a first network device, the method including: receiving, by the first network device, an internet protocol (IP) packet sent by a second network device; determining, by the first network device, a satellite radio interface-IP (SRI-IP) packet based on at least one of first information or a payload of the IP packet, where the first information is information added by the first network device; and sending, by the first network device, the SRI-IP packet to a third network device.

### CROSS-REFERENCE TO RELATED APPLICATIONS

The present application is a continuation application of International Application No. PCT/CN 2025/095209 filed on May 15, 2025, which claims priority to and benefits of Chinese patent application No. 202411677296.0, filed on Nov. 21, 2024, the entire contents of both of which are incorporated herein by reference.

### TECHNICAL FIELD

The present disclosure relates to a field of wireless communication technologies, in particular to a method and an apparatus for data transmission, a communication device, and a communication system.

### BACKGROUND

As base station technology continues to evolve, a New Radio (NR) Non-Terrestrial Network (NTN) 5th-Generation Mobile Communication Technology (5G) will define a Regenerative Payload, which has been clearly established. However, although a framework of a Satellite Radio Interface (SRI) protocol stack has been provided in relevant protocols, protocol functions have not been defined. Therefore, defining the protocol functions of the SRI protocol stack has become an essential task.

### SUMMARY

According to a first aspect of embodiments of the present disclosure, a method for data transmission is provided. The method is performed by a communication system including a first network device, and includes:
receiving, by the first network device, an internet protocol (IP) packet sent by a second network device;
determining, by the first network device, a satellite radio interface-IP (SRI-IP) packet based on first information and/or a payload of the IP packet, where the first information is information added by the first network device; and
sending, by the first network device, the SRI-IP packet to a third network device.

According to a second aspect of embodiments of the present disclosure, a method for data transmission is provided. The method is performed by a communication system including a third network device, and includes:
receiving, by the third network device, an S-IP packet sent by a fourth network device;
determining, by the third network device, an SRI-IP packet based on third information and/or a payload of the S-IP packet, where the third information is information added by the third network device; and
sending, by the third network device, the SRI-IP packet to a first network device.

According to a third aspect of embodiments of the present disclosure, a communication system is provided. The system includes a first network device. The first network device is configured to receive an IP packet sent by a second network device; determine an SRI-IP packet based on at least one of first information or a payload of the IP packet, where the first information is information added by the first network device; and send the SRI-IP packet to a third network device.

Additional aspects and advantages of the present disclosure will be described in part in the following description, some will become apparent from the description, or will be understood through practice of the present disclosure.

### BRIEF DESCRIPTION OF THE DRAWINGS

The above-mentioned and/or additional aspects and advantages of the present disclosure will become apparent and easy to understand from the descriptions of embodiments below in conjunction with the accompanying drawings.

FIG. 1a is a schematic diagram of a radio access network (RAN) architecture in a regenerative mode in related art.

FIG. 1b is a schematic diagram of a user plane protocol stack in a regenerative mode in related art.

FIG. 1c is a schematic diagram of a control plane protocol stack in a regenerative mode in related art.

FIG. 2 is a flowchart of a method for data transmission applicable to a first network device according to an embodiment of the present disclosure.

FIG. 3 is a flowchart of a method for data transmission applicable to a third network device according to an embodiment of the present disclosure.

FIG. 4 is a schematic diagram of a lightweight internet protocol (IP) solution of satellite radio interface (SRI) according to an embodiment of the present disclosure.

FIG. 5 is a flowchart of a ground Non-Terrestrial Network (NTN) Gateway sending data and/or information to a satellite base station according to an embodiment of the present disclosure.

FIG. 6 is a flowchart of a method for data transmission applicable to a third network device according to an embodiment of the present disclosure.

FIG. 7 is a flowchart of a method for data transmission applicable to a first network device according to an embodiment of the present disclosure.

FIG. 8 is a flowchart of a satellite base station sending data and/or information to a ground NTN Gateway according to an embodiment of the present disclosure.

FIG. 9 is a structural schematic diagram of an apparatus for data transmission according to an embodiment of the present disclosure.

FIG. 10 is a structural schematic diagram of an apparatus for data transmission according to an embodiment of the present disclosure.

FIG. 11 is a structural schematic diagram of an apparatus for data transmission according to an embodiment of the present disclosure.

FIG. 12 is a structural schematic diagram of an apparatus for data transmission according to an embodiment of the present disclosure.

FIG. 13 is a block diagram of a communication device according to an embodiment of the present disclosure.

### DETAILED DESCRIPTION

Embodiments of the present disclosure are described in details below, with examples illustrated in the accompanying figures. Same or similar reference numerals throughout the figures indicate same or similar components or components with the same or similar functions. The embodiments described below with reference to the figures are examples, and are intended for explanation of the present disclosure, instead of constituting a limitation of the present disclosure.

An end-to-end network architecture of a 5G Non-Terrestrial Network (NTN) is defined in relevant protocols.

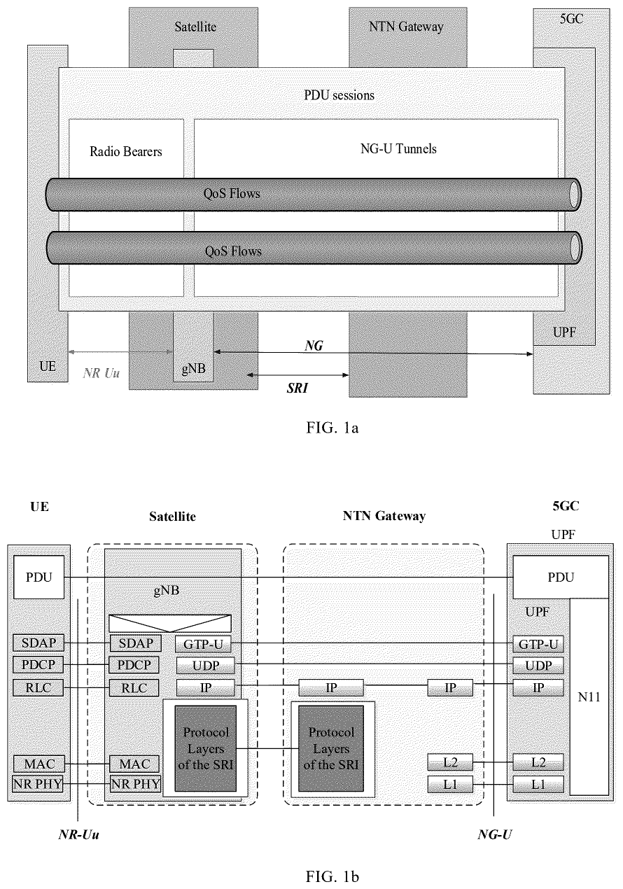

FIG. 1a is a schematic diagram of a radio access network (RAN) architecture in a regenerative mode in related art. In FIG. 1a, a Next Generation NodeB (gNB) on the Satellite (satellite-based base station) maintains a Protocol Data Unit (PDU) Session, a Quality of Service (QoS) flow, a Radio Bearer, and a Next Generation User Plane (NG-U) Tunnel, etc., that are the same as those in current 5G system, while introducing a satellite radio interface (SRI) between a gateway and a base station (satellite).

FIG. 1b is a schematic diagram of a user plane protocol stack in a regenerative mode in related art, and shows a framework of the SRI protocol stack between an NTN Gateway and a satellite (satellite base station). The SRI protocol stack forms a part of a Transport Network Layer (TNL) in the NG interface, located below an Internet Protocol (IP) layer, and input/output payload is an IP packet. The SRI protocol stack may be constituted of L3/L2/L1 or L2/L1 layers due to being located below the IP layer. When L3 is included, this portion of the protocol function implements an extension to an L3 IP packet processing function for SRI characteristics, such as encryption/decryption, a robustness mechanism based on a data IP packet, and a data adaptation mechanism based on a data IP packet.

FIG. 1c is a schematic diagram of a control plane protocol stack in a regenerative mode in related art. An SRI protocol stack shares the same framework as the SRI protocol stack of the user plane. The SRI protocol stack may be constituted of L3/L2/L1 or L2/L1 layers. When L3 is included, this portion of the protocol function is an extension to an L3 IP packet processing function for SRI characteristics, such as encryption/decryption, a robustness mechanism based on signaling an IP packet, and a rapid data transmission mechanism based on signaling an IP packet.

An NR NTN function defined in the relevant protocols operates in a Transparent Payload mode. In the Transparent Payload mode, the SRI protocol stacks shown in FIGS. 1b and 1c are not required, and a configuration of the SRI protocol stack is only required in a Regenerative Payload mode. Currently, the regenerative payload mode of deploying the base station functionality on the satellite has been completed, making the SRI a mandatory component of the NR NTN system.

However, although the relevant protocols specify the framework of the SRI protocol stack, protocol functions have not been defined.

In related art, when a gateway receives an IP packet from a core network destined for a satellite, the gateway is required to encapsulate the IP packet using multiple protocol layers (including a transport layer, a data link layer, and a physical layer) before transmission. This procedure introduces redundant data and increases overhead.

To address these problems, the present disclosure proposes a method and an apparatus for data transmission, a communication device, and a communication system that adopt a more simplified encapsulation method. A received IP packet is encapsulated into an SRI-IP packet and transmitted via a direct SRI between the sender and receiver. The method requires only one single encapsulation of the received IP packet, reducing unnecessary addition of protocol layer header information and control information, thereby lowering data overhead. Additionally, it avoids cross-layer transmission, enabling the data packet to be transmitted in the network in a more direct and efficient manner.

The following describes a method and an apparatus for data transmission, a communication device, and a communication system of embodiments of the present disclosure with reference to the accompanying drawings.

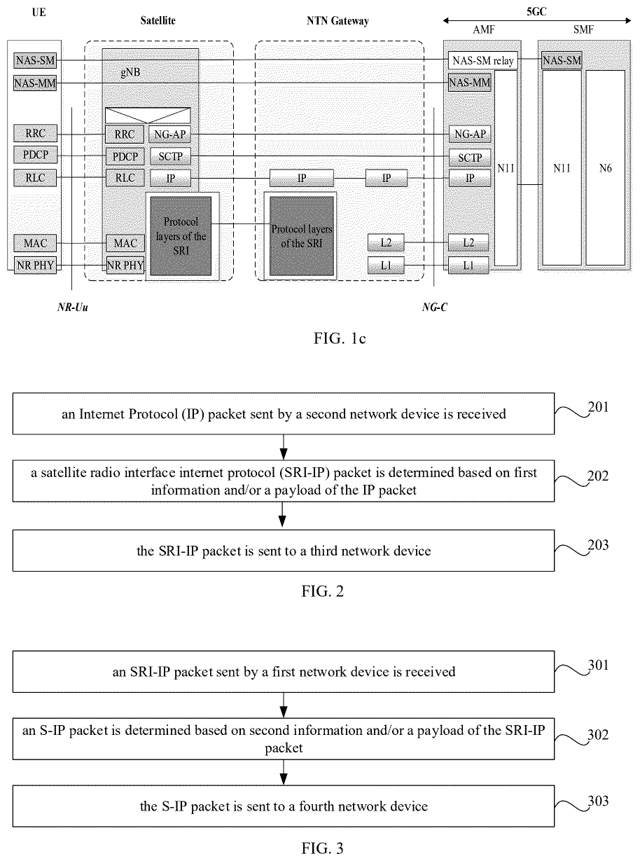

FIG. 2 is a flowchart illustrating a method for data transmission applicable to a first network device in an embodiment of the present disclosure. The first network device may be any network device that communicates data with a third network device.

As shown in FIG. 2, the method includes steps 201-203.

Step 201, an Internet Protocol (IP) packet sent by a second network device is received.

The second network device may be any network device required to transmit data to a third network device or a fourth network device. For example, the second network device may be any network device in a core network that is required to transmit data to a third network device or a fourth network device.

In some embodiments, the first network device and the third network device perform a point-to-point data transmission via an SRI. For instance, the first network device may be an NTN Gateway, the third network device may be a satellite, which specifically is a satellite base station, and the SRI is a direct connection interface between the satellite and the NTN Gateway. Since satellites operate in the sky or space while NTN Gateways remain stationary on the ground, the satellites select the NTN Gateways based on their orbyteal periodicity and ephemeris information. At any given time, a satellite maintains a deterministic logical connection to a NTN Gateway, which may be that the satellite direct connects with the NTN Gateway or the satellite connects with the NTN Gateway via an inter-satellite relay That is, there is always a satellite directly connects with an NTN Gateway via an SRI. Additionally, multiple NTN Gateways may coexist at the same ground station. For the NTN Gateways sharing ground station (or a cluster of NTN Gateways), a satellite may select any service NTN Gateway within the cluster for connection, and all NTN Gateways in the cluster are interconnected and interoperable. Once the satellite accesses any NTN Gateway, the satellite may connect with all NTN Gateways in the cluster (the NTN Gateways in the cluster may seamlessly switch with each other). Therefore, the NTN Gateway is in point-to-point transmission with the satellite, and the ground NTN Gateway cluster handles the seamless switching between NTN Gateways in the cluster while the satellite remain unaware.

As an example, the relationships among the first, second, third, and fourth network devices are as follows: the first network device may be an NTN Gateway and communicate with the third network device via an SRI for point-to-point transmission; the third network device may be a satellite directly connected with the NTN Gateway (the first network device), and performs the point-to-point transmission with the first network device via the SRI; the second network device may be any network device in a core network and performs data routing with the first network device via an IP function of ground routing; and the fourth network device may be another satellite that performs data transmission with the satellite (the third network device) directly connected with the NTN Gateway, and performs data routing with the third network device via an IP function of inter-satellite routing.

In some embodiments, for characteristics of the transmission between two network devices in the SRI, the present disclosure defines a lightweight IP of the SRI, the lightweight IP consists of three parts: an SRI-IP function, a satellite IP (S-IP) function, and a general IP (G-IP) function. The first network device is simultaneously provided with the SRI-IP function, the G-IP function, and an IP function. This allows the first network device to receive an IP packet sent by the second network device via the IP function and internally transfer the IP packet to the G-IP function.

As an example, a core network (the second network device) sends data, including user plane and control plane data, to a satellite base station (the third or fourth network device) via an Ng interface. The data packet arrives an IP function of an NTN Gateway (the first network device) via IP routing, and then is internally transferred to a G-IP function via the IP function.

Step 202, a satellite radio interface internet protocol (SRI-IP) packet is determined based on first information and/or a payload of the IP packet.

The first information is information added by the first network device.

In some embodiments, the SRI-IP packet includes at least one of:
an SRI-IP packet not carrying an IP address;
an SRI-IP packet carrying an IP address of the SRI; or
an SRI-IP packet carrying address identification information of the SRI.

If an SRI-IP packet does not carry an IP address, the SRI-IP packet is transmitted in a Transparent Payload mode of the SRI-IP. Specifically, after receiving the data packet from an upper layer Stream Control Transmission Protocol (SCTP)/User Datagram Protocol (UDP) (sending to a lower layer via a control plane data flow (C-IP flow) or user plane data flow (U-IP flow) according to SCTP/UDP), the data packet is directly sent to an SRI-IP at a receiving end. Alternatively, after receiving a data packet from a lower layer MAC, it is determined whether the data packet is a C-IP flow or a U-IP flow based on an IP flow ID, and then the data packet is directly sent to the upper layer (SCTP/UDP).

In some embodiments, the IP address of the SRI at least includes a destination IP address of the SRI-IP packet.
the IP address of the SRI uses a short IP address definition method, or in response to the IP address of the SRI using a long IP address definition method, the SRI-IP packet carries only a target segment of the IP address of the SRI which has a different value.

When the IP address of the SRI uses the long IP address definition method, the SRI-IP packet only carries the target segments with different values in the IP address of the SRI. This means that if the IP address of the SRI is the same in most byte segments, the SRI-IP packet only needs to carry those byte segments with different values. This may effectively reduce data redundancy and improve transmission efficiency.

That is, when the SRI-IP packet carries the IP address of the SRI, the IP address of the SRI may be defined using a short IP address, such as a version number field of the IP being IPV4, a port is a fixed port, or even the aforementioned information is not carried; the IP address may simply use an IP address of the IPV4 version. Alternatively, the IP address of the SRI may be defined using a long IP address. For uniform addressing of two network devices in the SRI, the SRI-IP packet does not carry information from the same byte segments, and only carries different byte segments. For example, for 255.255.255.xxx, 255.255.xxx. xxx, where after the uniform addressing, the information in the first 2 or 3 bytes is the same, so only the information in the last 2 or 1 byte needs to be carried in the SRI-IP packet.

In some embodiments, the address identification information includes at least one of: an identifier corresponding to an address pair of a source IP address and a destination IP address of the SRI-IP packet; an identifier corresponding to a source IP address of the SRI-IP packet; or an identifier corresponding to a destination IP address of the SRI-IP packet.

That is, the SRI-IP packet carries address identification information of the SRI, denoted as an SRI-ID. The SRI-ID of the SRI-IP packet may be in one-to-one mapping with a pair of the source IP address and the destination IP address of the SRI-IP packet (an SRI-ID of one SRI-IP packet corresponds to one address pair, and the address pair consists of a source IP address and a destination IP address of the SRI-IP packet). Alternatively, a SRI-ID may be assigned respectively to each of the source IP address and the destination IP address, i.e., the SRI-ID uniquely mapping to the source IP address or the destination IP address of the SRI-IP packet (an SRI-ID of one SRI-IP packet corresponds to a source IP address or a destination IP address of the SRI-IP packet). For example, if the SRI-ID is of 2 bytes, it may represent 0 to 65535 addresses, which may cover a total number of two network devices in the SRI. The two network devices in the SRI may be uniformly numbered with SRI-IDs (sharing 65536 ID numbers), or independently numbered with SRI-IDs (each having 65536 available IDs). The SRI-ID is carried in the IP of the SRI-IP packet, while IP address-related information is not carried. The sender and the receiver retrieve the IP address and corresponding information based on the SRI-ID, thus achieving efficient transmission of the IP address.

In some embodiments, the address identification information is indicated by Compressed IP Flow Identifier (C-IP flow ID) or Derived IP Flow Identifier (D-IP flow ID). The C-IP flow ID and the D-IP flow ID generate shorter identifiers through compression or derivation to simplify the IP addresses.

In some embodiments, the first network device may first parse the IP packet to obtain the payload of the IP packet, and then determine the SRI-IP packet based on the first information and/or the payload of the IP packet.

In some embodiments, for characteristics of the transmission between two network devices in the SRI, the present disclosure defines a lightweight IP of the SRI, the lightweight IP consists of three parts: an SRI-IP function, an S-IP function, and a G-IP function. The first network device is simultaneously provided with the SRI-IP function, the G-IP function, and an IP function. This allows the first network device to first parse the IP packet through the G-IP function to obtain the payload of the IP packet, which is a data packet (an SCTP/UDP data packet) from the SCTP (control plane) or the UDP (user plane). Subsequently, the SRI-IP packet is constructed based on the first information and/or the payload of the IP packet through the SRI-IP function. The first information and/or the payload of the IP packet are internally transferred to the SRI-IP function by the first network device through the G-IP function. In other words, the first network device may also internally transfer the parsed payload of the IP packet and/or information added by the first network device ((first information)) to the SRI-IP function through the G-IP function.

In some embodiments, the first information includes at least one of: status information; measurement information; or data reception and transmission state information.

The status information pertains to an overall status and a changing trend of a satellite communication system. The status information includes at least one of:
a satellite position and orbital parameters, such as longitude, latitude, altitude, etc.;
a satellite operation state, such as a power state, a temperature, a pressure, etc.;
a communication link quality, such as a signal strength, a bit error rate, etc.; or
an interference condition, such as interference from another satellite or a ground device.

The measurement information refers to data related to a performance of a satellite communication system obtained through measurement techniques. This measurement information includes at least one of:
received power and transmitted power of a satellite signal;
a frequency and a phase of a signal;
a bit error rate and a packet loss rate; or
latency and jitter of the satellite communication system.

The data reception and transmission state information refers to state information of a data transmission and reception procedure in a satellite communication system. The data reception and transmission state information includes at least one of:
a sending timestamp and a receiving timestamp of a data packet;
a sequence number and a check code of a data packet;
a loss situation and a retransmission situation of a data packets; or
a data transmission rate and throughput.

The aforementioned status information, measurement information, and data reception and transmission state information may be detected by the first network device via the G-IP function.

In some embodiments, determining, by the first network device, the SRI-IP packet based on the first information and/or the payload of the IP packet includes at least one of:
in a case that the SRI-IP packet does not carry the IP address, the SRI-IP packet is determined based on the first information and/or the payload of the IP packet (i.e., when the SRI-IP packet does not carry the IP address, the first information and/or the payload of the IP packet may be directly used as the SRI-IP packet);
in a case that the SRI-IP packet carries the IP address of the SRI, the first information and/or the payload of the IP packet is used as a payload of the SRI-IP packet, and the SRI-IP packet is determined based on the payload of the SRI-IP packet and the IP address of the SRI (i.e., when the SRI-IP packet carries the IP address of the SRI, the first information and/or the payload of the IP packet may be used as the payload of the SRI-IP packet, and then the IP address of the SRI is added, to obtain the SRI-IP packet);
in a case that the SRI-IP packet carries the address identification information of the SRI, the first information and/or the payload of the IP packet is used as a payload of the SRI-IP packet, and the SRI-IP packet is determined based on the payload of the SRI-IP packet and the address identification information of the SRI (i.e., when the SRI-IP packet carries the address identification information of the SRI, the first information and/or the payload of the IP packet may be used as the payload of the SRI-IP packet, and then the address identification information of the SRI is added, to obtain the SRI-IP packet).

That is, the payload in the SRI-IP packet may not only contain the data information of the IP packet, but may also be added with a variety of status information, measurement information, and the data reception and transmission state information that is detected by the G-IP function.

Step 203, the SRI-IP packet is sent to a third network device.

In some embodiments, for characteristics of the transmission between two network devices in the SRI, the present disclosure defines a lightweight IP of the SRI, the lightweight IP consists of three parts: an SRI-IP function, an S-IP function, and a G-IP function. The first network device is simultaneously provided with the SRI-IP function, the G-IP function, and an IP function. This allows the first network device to send the SRI-IP packet to the third network device via the SRI-IP function. Specifically, the SRI-IP packet may be sent to the third network device via the direct connection interface (i.e., the SRI) between the first network device and third network device.

According to the above embodiments, the first network device receives the IP packet sent by the second network device; the first network device determines the SRI-IP packet based on the first information and/or the payload of the IP packet, where the first information is information added by the first network device; and the first network device sends the SRI-IP packet to the third network device. In this procedure, the first network device performs the point-to-point transmission with the third network device via the SRI, the first network device encapsulates the received IP packet as the SRI-IP packet, and transmits the SRI-IP packet via the directly connection interface, i.e., the SRI between the first network device and the third network device. Accordingly, only one encapsulation of the received IP packet is required, which reduces the addition of unnecessary protocol layer header information and control information, lowers data overhead, enables near-zero IP layer overhead, and helps to transmit more data or provide higher throughput under limited network bandwidth conditions. Meanwhile, the method avoids cross-layer transmission, and allows the data packet to be transmitted in a more direct and efficient manner within the network.

The above embodiments are described from the perspective of the first network device. To illustrate the aforementioned data transmission procedure more clearly, embodiments of the present disclosure provide implementations of a method for data transmission that are described from a perspective of a third network device. FIG. 3 is a flowchart of a method for data transmission applicable to a third network device provided by an embodiment of the present disclosure. Similarly, the third network device may be any network device that performs data transmission with the first network device.

As shown in FIG. 3, the method includes the following steps of 301-303.

Step 301, an SRI-IP packet sent by a first network device is received.

The SRI-IP packet is determined by the first network device based on first information and/or a payload of a received IP packet sent by a second network device. The first information is information added by the first network device.

In some embodiments, the first network device and the third network device perform a point-to-point data transmission via an SRI. For relevant explanations, reference may be made to the descriptions of the embodiments of the present disclosure, which will not be repeated here.

In some embodiments, the SRI-IP packet includes at least one of: an SRI-IP packet not carrying an IP address; an SRI-IP packet carrying an IP address of the SRI; an SRI-IP packet carrying address identification information of the SRI.

For relevant explanations, reference may be made to the descriptions of the embodiments of the present disclosure, which will not be repeated here.

In some embodiments, the IP address of the SRI includes at least a destination IP address of the SRI-IP packet; and

the IP address of the SRI uses a short IP address definition method, or in response to the IP address of the SRI using a long IP address definition method, the SRI-IP packet carries only a target segment of the IP address of the SRI which has a different value.

For relevant explanations, reference may be made to the descriptions of the embodiments of the present disclosure, which will not be repeated here.

In some embodiments, the address identification information includes at least one of:
an identifier corresponding to an address pair of a source IP address and a destination IP address of the SRI-IP packet;
an identifier corresponding to a source IP address of the SRI-IP packet; or
an identifier corresponding to a destination IP address of the SRI-IP packet.

For relevant explanations, reference may be made to the descriptions of the embodiments of the present disclosure, which will not be repeated here.

In some embodiments, the address identification information is indicated by a C-IP flow ID or a D-IP flow ID. The C-IP flow ID and the D-IP flow ID generate a shorter identifier through compression or derivation to simplify the IP addresses.

In some embodiments, the first information includes at least one of:
status information;
measurement information; or
data reception and transmission state information.

For relevant explanations, reference may be made to the descriptions of the various embodiments of the present disclosure, which will not be repeated here.

In some embodiments, for characteristics of the transmission between two network devices in the SRI, the present disclosure defines a lightweight IP of the SRI, the lightweight IP consists of three parts: an SRI-IP function, an S-IP function, and a G-IP function. The third network device is simultaneously provided with the SRI-IP function and the S-IP function. This allows the third network device to receive the SRI-IP packet sent by the first network device via the SRI-IP function. Specifically, the SRI-IP packet sent by the first network device may be received via the direct connection interface (i.e., the SRI) between the first network device and third network device.

Step 302, an S-IP packet is determined based on second information and/or a payload of the SRI-IP packet.

The second information is information added by the third network device.

In some embodiments, the third network device may first parse the SRI-IP packet to obtain the payload of the SRI-IP packet, and then determine the S-IP packet based on the second information and/or the payload of the SRI-IP packet.

In some embodiments, for characteristics of the transmission between two network devices in the SRI, the present disclosure defines a lightweight IP of the SRI, the lightweight IP consists of three parts: an SRI-IP function, an S-IP function, and a G-IP function. The third network device is provided with both the SRI-IP function and the S-IP function. This allows the third network device to first parse the SRI-IP packet via the SRI-IP function to obtain the payload of the SRI-IP packet, i.e., the payload of the IP packet (SCTP/UDP packet) sent by the second network device and/or the information (first information) added by the first network device. Subsequently, in a case of non-local processing, the parsed payload of the SRI-IP packet is internally transferred to the S-IP function through the SRI-IP function. Finally, the S-IP packet is constructed via the S-IP function based on the information (second information) added by the third network device and/or the payload of the SRI-IP packet.

It should be noted that in a case of local processing (i.e., the SRI-IP packet is sent to the third network device), the third network device will send the parsed payload of the SRI-IP packet to an upper layer of the IP, namely an SCTP or UDP function, via the SRI-IP function.

As an example, after receiving an SRI-IP packet via an SRI-IP function, a satellite base station (the third network device) parses the SRI-IP packet to obtain a payload of the SRI-IP packet, i.e., a payload of an IP packet (SCTP/UDP data packet) sent by a core network and/or information (first information) added by an NTN Gateway (the first network device). If the SRI-IP packet is sent to the satellite base station, the payload of the SRI-IP packet is sent to an upper layer of the IP, that is, an SCTP or UDP function. Otherwise, inter-satellite routing is performed (the parsed payload of the SRI-IP packet is internally transferred to an S-IP function via the SRI-IP function, and an S-IP packet is constructed via the S-IP function based on the payload of the SRI-IP packet and/or information (second information) added by the satellite base station, and is routed to a target satellite base station (a fourth network device)).

Step 303, the S-IP packet is sent to a fourth network device.

In some embodiments, for characteristics of the transmission between two network devices in the SRI, the present disclosure defines a lightweight IP of the SRI, the lightweight IP consists of three parts: an SRI-IP function, an S-IP function, and a G-IP function. The third network device is provided with both the SRI-IP function and the S-IP function. This allows the third network device to send the S-IP packet to the fourth network device via the S-IP function.

In the above embodiments, the third network device receives the SRI-IP packet sent by the first network device, where the SRI-IP packet is determined by the first network device based on the first information and/or the payload of the IP packet received from the second network device, and the first information is the information added by the first network device; the S-IP packet is determined based on the second information and/or the payload of the SRI-IP packet, where the second information is information added by the third network device; and the S-IP packet is sent to the fourth network device. In this procedure, the point-to-point transmission is performed between the first network device and the third network device via the SRI, and the third network device receives the SRI-IP packet via the direct connection interface (i.e., the SRI) between the first network device and the third network device, which achieves near-zero IP layer overhead, helps to transmit more data or provide higher throughput under limited network bandwidth conditions. Meanwhile, the method avoids cross-layer transmission, and allows the data packet to be transmitted in a more direct and efficient manner within the network.

To clearly illustrate the data transmission procedure described in the aforementioned embodiments, examples are provided for explanation.

First, an example of the lightweight IP scheme for the SRI defined in the present disclosure will be illustrated.

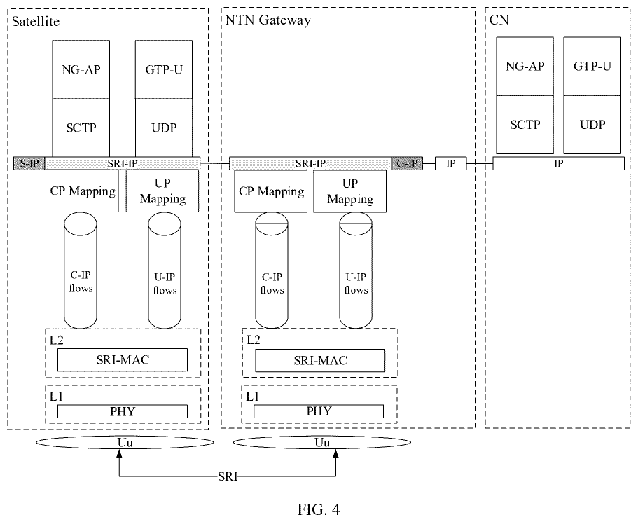

FIG. 4 is a schematic diagram of a lightweight IP scheme for the SRI provided by an embodiment of the present disclosure.

As shown in FIGS. 1b and 1c, an SRI protocol stack is a part of a TNL in an NG interface. An IP (sub) layer serves as a routing protocol layer for achieving a communication from a satellite to a core network. Information exchanged between the satellite and the core network is forwarded to a target device via an NTN Gateway. An SRI is a direct connection interface between the NTN Gateway and the satellite. An IP routing transmission between the satellite and the NTN Gateway is a point-to-point transmission. For transmission characteristics between the satellite and the NTN Gateway in the SRI, the present disclosure defines a lightweight IP of the SRI, denoted as SRI-IP.

The SRI serves as the direct connection interface between the satellite and the NTN Gateway, as illustrated in FIG. 4. The SRI-IP completes the point-to-point transmission of data at the IP layer within the SRI. The point-to-point transmission of the SRI is the point-to-point transmission between the satellite and the NTN Gateway.

As shown in FIG. 4, the lightweight IP in the SRI defined in the present disclosure consists of three parts: one is an SRI-IP function, one is a general IP function targeted for ground routing, denoted as G-IP function, and one is a satellite IP function targeted for inter-satellite routing, denoted as S-IP function.

The satellite is provided with both the SRI-IP and S-IP functions, and the NTN Gateway is simultaneously provided with the SRI-IP function, the G-IP functions, and an IP function of ground routing (as shown in an unfilled IP block in FIG. 4).

The SRI-IP function on the satellite and the SRI-IP function on the NTN Gateway are SRI peer-to-peer IP functions.

The SRI-IP function on the satellite is used to receive an SRI-IP packet sent by the NTN Gateway, parse the SRI-IP packet, and in the case of non-local processing, move a payload of the parsed SRI-IP packet internally to the S-IP function on the satellite, or alternatively, the SRI-IP function on the satellite is used to construct an SRI-IP packet based on a payload of an S-IP packet and/or third information (the payload of the S-IP packet is obtained through internally transfer by the S-IP function on the satellite, and the third information is added by the satellite), and send the constructed SRI-IP packet to the NTN Gateway via the direct connection interface (the SRI) between the satellite and the NTN Gateway.

The SRI-IP function on the NTN Gateway is used to construct an SRI-IP packet based on a payload of an IP packet and/or first information (the payload of the IP packet and/or the first information are obtained through internal transfer by the G-IP function on the NTN Gateway, and the first information is information added by the NTN Gateway), and send the constructed SRI-IP packet to the satellite via the direct connection interface (the SRI) between the satellite and the NTN Gateway. Alternatively, the NTN Gateway receives the SRI-IP packet sent by the satellite, parses the SRI-IP packet, and internally transfers the parsed payload of the SRI-IP packet to the G-IP function on the NTN Gateway.

In the SRI-IP packet, (1) an IP address may not be carried; (2) an IP header information with a short IP address may be carried, i.e., an IP address of the SRI-IP packet is an independent addressing for the SRI and may be different from a general IP address, to achieve isolation of the IP connection; (3) address identification information customized by the SRI may be carried.

(1) If the SRI-IP packet does not carry the IP address, the SRI-IP packet is transmitted in a Transparent Payload mode of the SRI-IP. Specifically, after receiving the data packet from an upper layer SCTP/UDP (sending to a lower layer via a C-IP flow or U-IP flow according to SCTP/UDP), the data packet is directly sent to an SRI-IP at a receiving end. Alternatively, after receiving a data packet from a lower layer MAC, it is determined whether the data packet is a C-IP flow or a U-IP flow based on an IP flow ID, and then the data packet is directly sent to the upper layer (SCTP/UDP).

(2) The SRI-IP packet carries the IP address of the SRI using a short IP address definition method. For example, a version number field of the IP is IPV4, a port is a fixed port, or even the aforementioned information is not carried; the IP address may simply use an IP address of the IPV4 version, or even through unified addressing of satellite SRI-IP and gateway SRI-IP in the SRI, the same byte segment information is not carried, only different byte segments are carried. For example, for 255.255.255.xxx, 255.255.xxx.xxx, where after the uniform addressing, the information in the first 2 or 3 bytes is the same, so only the information in the last 2 or 1 byte needs to be carried in the IP packet. The satellite and the NTN Gateway may store constellation topology information in time units. This IP address serves as an index to retrieve topology information within the time period, thus establishing a mapping relationship for retrieving ephemeris with both IP address and time.

(3) The SRI-IP packet carries the address identification information of the SRI, denoted as SRI-ID. The SRI-ID may be in one-to-one mapping with a pair of the source IP address and the destination IP address of the SRI-IP packet. Alternatively, a SRI-ID may be assigned respectively to each of the source IP address and the destination IP address, and thus each of the SRI-IDs is uniquely mapping to the IP address of the source or destination SRI-IP. For example, if the SRI-ID is of 2 bytes, it may represent 0 to 65535 addresses, which may cover a total number of the ground NTN Gateways and satellites. The NTN Gateway and the satellite may be uniformly numbered with SRI-IDs (sharing 65536 ID numbers), or independently numbered with SRI-IDs (each having 65536 available IDs). The SRI-ID is carried in the IP of the SRI-IP, while IP address-related information is not carried. The sender and the receiver both retrieve the IP address and corresponding information based on the SRI-ID, thus achieving efficient transmission of the IP address.

The G-IP function serves as an IP conversion function in the SRI of the NTN Gateway. According to the function definition of SRI-IP, the G-IP function is used to parse a general IP packet (where the IP packet is obtained by internal transfer by the IP function for ground routing on the NTN Gateway), and to internally transfer a parsed payload of the IP packet and/or the first information (the first information is information added by the NTN Gateway) to the SRI-IP function on the NTN Gateway. Alternatively, the G-IP function is used to construct the IP packet based on a payload of the SRI-IP packet and/or fourth information (the payload of the SRI-IP packet is obtained by internal transfer through the SRI-IP function on the NTN Gateway, and the fourth information is information added by the NTN Gateway), and to internally transfer the IP packet to the IP function for ground routing on the NTN Gateway, in which the IP packet is then routed by the IP function for ground routing on the NTN Gateway to the core network.

The S-IP function serves as an IP conversion function in the SRI of the satellite. According to the function definition of the SRI-IP and the IP function definition of inter-satellite routing, the S-IP function is used to construct the S-IP packet based on the payload of the SRI-IP packet and/or the second information (the payload of the SRI-IP packet is obtained by internally transfer through the SRI-IP function on the satellite, and the second information is information added by the satellite), and to send the S-IP packet to the target satellite. Alternatively, the S-IP function is used to receive the S-IP packet sent by another satellite via the S-IP function, to parse the S-IP packet, and to internally transfer the parsed payload of the S-IP packet to the SRI-IP function on the satellite. That is, the S-IP function serves as an IP function for inter-satellite IP routing, enabling data routing between the satellite directly connected with the NTN Gateway and the data source satellite.

The IP function for ground routing on the NTN Gateway is used to complete data routing of the Ng interface, including signaling information exchange for an NG-Application Protocol (NG-AP) and information exchange for General Packet Radio Service (GPRS) Tunneling Protocol-User Plane (GTP-U).

Next, the interaction procedures of FIG. 2 and FIG. 3 are illustrated with examples.

FIG. 5 is a flowchart of an NTN Gateway sending data and/or information to a satellite base station provided by an embodiment of the present disclosure.

As shown in FIG. 5, the procedure includes steps 501-508.

Step 501, a core network (CN) sends an Ng interface IP packet to be sent to a satellite base station to a G-IP function of any NTN Gateway.

The core network sends data, including user plane and control plane data, to the satellite base station via the Ng interface. The data packet is routed through IP to reach the G-IP function of any NTN Gateway.

Step 502, the G-IP function on the NTN Gateway, which receives the Ng interface IP packet sent by the core network, calculates routing and selects an NTN Gateway from an NTN Gateway Cluster.

Upon receiving the Ng interface IP packet sent by the core network, the G-IP function on the NTN Gateway parses the IP packet to obtain a payload of the IP packet, which is either an SCTP (control plane) or UDP (user plane) packet (SCTP/UDP packet), and completes the routing selection of the NTN Gateway or the NTN Gateway cluster.

As an implementation, the G-IP function on the NTN Gateway, which receives the Ng interface IP packet sent by the core network, may select, based on the routing information of the IP packet, an NTN Gateway from the NTN Gateway cluster where the NTN Gateway is located, and the selected NTN Gateway may send the IP packet to the satellite. Alternatively, the G-IP function may select an NTN Gateway cluster based on the routing information of the IP packet, and select an NTN Gateway from the selected NTN Gateway cluster, and the selected NTN Gateway sends the IP packet to the satellite.

It should be noted that the NTN Gateway receiving the Ng interface IP packet sent by the core network may select itself to send the data and/or information to the satellite base station, or select another NTN Gateway from the NTN Gateway cluster to send the data and/or information to the satellite base station.

Step 503, the payload of the IP packet and/or information added by the selected NTN Gateway is internally transferred.

If the G-IP function of the NTN Gateway, which receives the Ng interface IP packet sent by the core network, selects itself to send the data and/or information to the satellite base station, the parsed SCTP/UDP data packet and/or the information (first information) added by the NTN Gateway is internally transferred to the SRI-IP function through the G-IP function of the NTN Gateway.

If the G-IP function of the NTN Gateway, which receives the Ng interface IP packet sent by the core network, selects another NTN Gateway from the NTN Gateway cluster to send the data and/or information to the satellite base station, then the Ng interface IP packet sent by the core network is forwarded, through the IP function for ground routing on the NTN Gateway, to the selected NTN Gateway. The selected NTN Gateway receives the Ng interface IP packet sent by the core network and internally transfers the Ng interface IP packet to a G-IP function through an IP function for ground routing on the NTN Gateway, parses the IP packet through the G-IP function to obtain a corresponding IP packet payload, which is the data packet from the SCTP (control plane) or UDP (user plane), and internally transfers, through the G-IP function, the parsed SCTP/UDP data packet and/or information (first information) added by the selected NTN Gateway to an SRI-IP function.

Step 504, the SRI-IP function on the NTN Gateway, which sends the data and/or information to the satellite base station, constructs an SRI-IP packet.

For relevant explanations of the construction of the SRI-IP package, reference may be made to the descriptions of various embodiments of the present disclosure, and will not be repeated here.

Step 505, the SRI-IP function on the NTN Gateway, which sends the data and/or information to the satellite base station, sends the SRI-IP packet to the satellite base station via an SRI.

Step 506, an SRI-IP function on the satellite base station receives the SRI-IP packet, parses the SRI-IP packet, obtains a payload of the SRI-IP packet, and performs local processing or inter-satellite routing.

Upon receiving the SRI-IP packet, the SRI-IP function on the satellite base station parses the SRI-IP packet to obtain the payload of the SRI-IP packet, which consists of the SCTP/UDP packet and/or the first information. If the SRI-IP packet is intended to be sent to the satellite base station, the SRI-IP function forwards the SRI-IP packet to an upper layer of the IP, i.e., an SCTP or UDP function. Otherwise, inter-satellite routing is performed (internally transferring the parsed payload of the SRI-IP packet to an S-IP function through the SRI-IP function, then constructing an S-IP packet based on the payload of the SRI-IP packet and/or information (second information) added by the satellite base station, and routing the S-IP packet to the target satellite base station).

Step 507, the payload of the SRI-IP packet is internally transferred.

The satellite base station transfers the parsed payload of the SRI-IP packet internally to the S-IP function through the SRI-IP function.

Step 508, inter-satellite routing is performed.

The satellite base station constructs the S-IP packet based on the payload of the SRI-IP packet and/or the information (second information) added by the satellite base station through the S-IP function, and routes the S-IP packet to the target satellite base station through the S-IP function.

Therefore, for sending the data and/or information from the core network to the satellite base station, the IP packet is sent to the direct-connected satellite via the NTN Gateway, and the packet is processed on the satellite base station or routed to the destination satellite base station via the direct-connected satellite. Therefore, through the SRI-IP, near-zero IP layer overhead may be achieved, and the routing of the space-based network and ground network may be independent and isolated, avoiding mutual influence on routing updates between the two. Furthermore, the SRI-IP defines a unified interface for the space-based and ground-based networks, enabling plug-and-play functionality. In addition, by fully delegating the processing of ground IP routing to the ground NTN Gateway, the load on the satellite-to-ground routing is reduced.

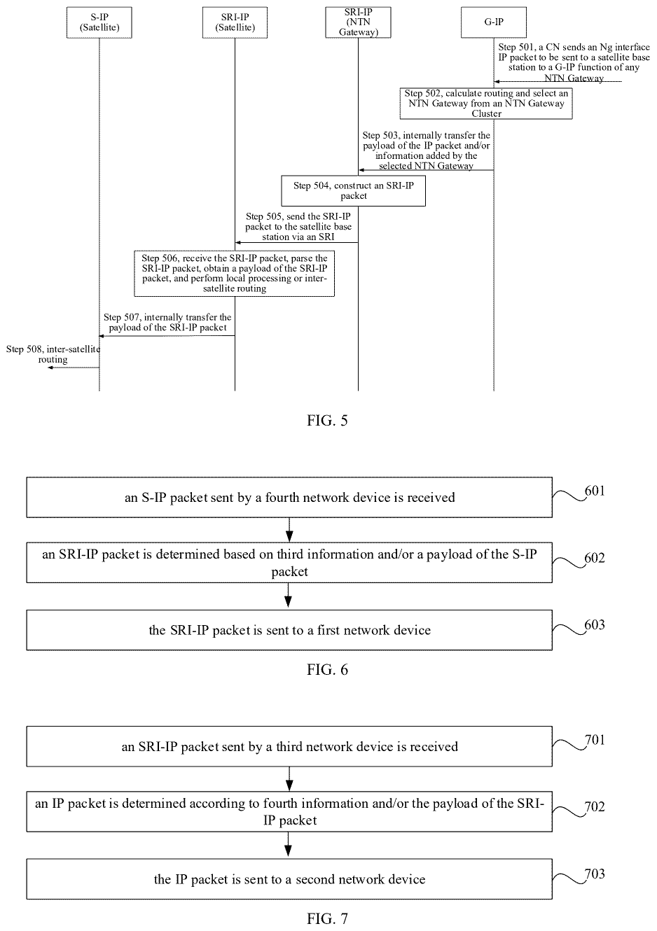

Corresponding to the second network device sending data to the fourth network device via the first and third network devices, the fourth network device may also send data to the second network device via the first and third network devices. With reference to FIG. 6, a data transmission procedure for the third network device side is described below.

FIG. 6 is a flowchart of another method for data transmission applicable to a third network device provided by another embodiment of the present disclosure. The third network device may be any network device that performs data transmission with a first network device.

As shown in FIG. 6, the method includes steps 601-603.

Step 601, an S-IP packet sent by a fourth network device is received.

The fourth network device may be any network device that needs to send data to a second network device.

In some embodiments, for transmission characteristics between two network devices in an SRI, the present disclosure defines a lightweight IP for the SRI. The protocol consists of three parts: an SRI-IP function, an S-IP function, and a G-IP function. The third network device and the fourth network device both are provided with the SRI-IP function and the S-IP function, so that the third network device may receive, through the S-IP function, the S-IP packet sent by the fourth network device through the S-IP function.

Step 602, an SRI-IP packet is determined based on third information and/or a payload of the S-IP packet.

The third information is information added by the third network device.

In some embodiments, the SRI-IP packet includes at least one of:
an SRI-IP packet not carrying an IP address;
an SRI-IP packet carrying an IP address of the SRI; or
an SRI-IP packet carrying address identification information of the SRI.

For relevant explanations, reference may be made to the descriptions of the various embodiments of the present disclosure, and will not be repeated here.

In some embodiments, the IP address of the SRI includes at least a destination IP address of the SRI-IP packet; and
the IP address of the SRI uses a short IP address definition method, or in response to the IP address of the SRI using a long IP address definition method, the SRI-IP packet carries only a target segment of the IP address of the SRI which has a different value.

For relevant explanations, reference may be made to the various embodiments of the present disclosure, and will not be repeated here.

In some embodiments, the address identification information includes at least one of:
an identifier corresponding to an address pair of a source IP address and a destination IP address of the SRI-IP packet;
an identifier corresponding to a source IP address of the SRI-IP packet; or
an identifier corresponding to a destination IP address of the SRI-IP packet.

For relevant explanations, reference may be made to the various embodiments of the present disclosure, and will not be repeated here.

In some embodiments, the address identification information is indicated by a C-IP flow ID or a D-IP flow ID. The C-IP flow ID and the D-IP flow ID generate shorter identifiers through compression or derivation to simplify the IP address.

In some embodiments, the third network device may first parse the S-IP packet to obtain the payload of the S-IP packet, and then determine the SRI-IP packet based on the third information and/or the payload of the S-IP packet.

In some embodiments, for transmission characteristics between two network devices in the SRI, the present disclosure defines a lightweight IP for the SRI. The protocol consists of three parts: an SRI-IP function, an S-IP function, and a G-IP function. The third network device is provided with both the SRI-IP function and the S-IP function, so that the third network device may first parse the S-IP packet through the S-IP function to obtain the payload of the S-IP packet, i.e., the SCTP/UDP packet sent by the fourth network device. Then, in a case of non-local processing, the payload of the parsed S-IP packet is internally transferred to the SRI-IP function through the S-IP function. Finally, based on the payload of the S-IP packet and/or the information added by the third network device (third information), the SRI-IP packet is constructed through the SRI-IP function.

It should be noted that in a case of local processing (the S-IP packet is sent to the third network device), the third network device sends the parsed payload of the S-IP packet to a local SCTP or UDP function for processing through the S-IP function.

In some embodiments, determining, by the third network device, the SRI-IP packet based on the third information and/or the payload of the SRI-IP packet includes at least one of:
in a case that the SRI-IP packet does not carry the IP address of the SRI, the SRI-IP packet is determined based on the third information and/or the payload of the S-IP packet (i.e., when the SRI-IP packet does not carry the IP address, the third information and/or the payload of the S-IP packet may be directly used as the SRI-IP packet);
in a case that the SRI-IP packet carries the IP address of the SRI, the third information and/or the payload of the S-IP packet is used as the payload of the SRI-IP packet, and the SRI-IP packet is determined based on the payload of the SRI-IP packet and the IP address of the SRI (i.e., when the SRI-IP packet carries the IP address of the SRI, the third information and/or the payload of IP packet may be taken as the payload of the SRI-IP packet, and then the IP address of the SRI is added, to obtain the SRI-IP packet);
in a case that the SRI-IP packet carries the address identification information of the SRI, the third information and/or the payload of the S-IP packet is used as the payload of the SRI-IP packet, and the SRI-IP packet is determined based on the payload of the SRI-IP packet and the address identification information of the SRI (i.e., when the SRI-IP packet carries the address identification information of the SRI, the third information and/or the payload of the IP packet may be used as the payload of the SRI-IP packet, and then the address identification information of the SRI is added, to obtain the SRI-IP packet).

That is, the payload in SRI-IP packets may not only contain the data information of the S-IP packet, but may also be added with information (third information) added by the third network device.

Step 603, the SRI-IP packet is sent to a first network device.

In some embodiments, the first network device and the third network device perform point-to-point data transmission via the SRI. For relevant explanations, reference may be made to the various embodiments of the present disclosure, and will not be repeated here.

In some embodiments, or characteristics of the transmission between two network devices in the SRI, the present disclosure defines a lightweight IP of the SRI. The protocol consists of three parts: an SRI-IP function, an S-IP function, and a G-IP function. The third network device is provided with both the SRI-IP function and the S-IP function, so that the third network device may send the SRI-IP packet to the first network device through the SRI-IP function. Specifically, the SRI-IP packet may be sent to the first network device through the direct connection interface (the SRI) between the first network device and the third network device.

According to the above embodiments, the third network device receives the S-IP packet sent by the fourth network device; determines the SRI-IP packet based on the third information and/or the payload of S-IP packet, where the third information is information added by the third network device; and sends the SRI-IP packet to the first network device. In this procedure, the first network device performs the point-to-point transmission with the third network device via the SRI. The third network device encapsulates the received S-IP packet into the SRI-IP packet and transmits the SRI-IP packet through the direct connection interface, i.e., the SRI, between the first network device and the third network device. Accordingly, only one encapsulation of the received IP packet is required, which reduces the addition of unnecessary protocol layer header information and control information, lowers data overhead, enables near-zero IP layer overhead, and helps to transmit more data or provide higher throughput under limited network bandwidth conditions. Meanwhile, the method avoids cross-layer transmission, and allows the data packet to be transmitted in a more direct and efficient manner within the network.

The above embodiments are described from the perspective of the first network device. To illustrate the aforementioned data transmission procedure more clearly, embodiments of the present disclosure provide implementations of a method for data transmission that are described from a perspective of a first network device. FIG. 7 is a flow diagram of another method for data transmission applicable to a first network device provided by another embodiment of the present disclosure. Similarly, the first network device may be any network device that performs data transmission with a third network device.

As shown in FIG. 7, the method includes steps 701-703.

Step 701, an SRI-IP packet sent by a third network device is received.

The SRI-IP packet is determined by the third network device based on third information and/or a payload of a received S-IP packet sent by a fourth network device, and the third information is information added by the third network device.

In some embodiments, the first network device and the third network device perform a point-to-point data transmission via an SRI. For relevant explanations, reference may be made to the descriptions in the embodiments of the present disclosure, and will not be repeated here.

In some embodiments, the SRI-IP packet include at least one of:
an SRI-IP packet not carrying an IP address;
an SRI-IP packet carrying an IP address of the SRI; or
an SRI-IP packet carrying address identification information of the SRI.

For relevant explanations, reference may be made to the descriptions in the embodiments of the present disclosure, and will not be repeated here.

In some embodiments, the IP address of the SRI at least includes a destination IP address of the SRI-IP packet; and
the IP address of the SRI uses a short IP address definition method, or in response to the IP address of the SRI using a long IP address definition method, the SRI-IP packet carries only a target segment of the IP address of the SRI which has a different value.

For relevant explanations, reference may be made to the descriptions in the embodiments of the present disclosure, and will not be repeated here.

In some embodiments, the address identification information includes at least one of:
an identifier corresponding to an address pair of a source IP address and a destination IP address of the SRI-IP packet;
an identifier corresponding to a source IP address of the SRI-IP packet; or
an identifier corresponding to a destination IP address of the SRI-IP packet.

For relevant explanations, reference may be made to the descriptions in the embodiments of the present disclosure, and will not be repeated here.

In some embodiments, address identification information is indicated by a C-IP flow ID or a D-IP flow ID. The C-IP flow ID and D-IP flow ID generate shorter identifiers through compression or derivation to simplify the IP addresses.

In some embodiments, for characteristics of the transmission between two network devices in the SRI, the present disclosure defines a lightweight IP of the SRI, the lightweight IP consists of three parts: an SRI-IP function, an S-IP function, and a G-IP function. The first network device is provided with the SRI-IP function, the G-IP function and an IP function at the same time, so that the first network device may receive the SRI-IP packet sent by the third network device through the SRI-IP function. Specifically, the SRI-IP packet sent by the third network device may be received via the direct connection interface (i.e., the SRI) between the first network device and the third network device.

Step 702, an IP packet is determined according to fourth information and/or the payload of the SRI-IP packet.

The fourth information is information added by the first network device.

In some embodiments, the first network device may first parse the SRI-IP packet to obtain the payload of the SRI-IP packet, and then determine the IP packet based on the fourth information and/or the payload of the SRI-IP packet.

In some embodiments, for characteristics of the transmission between two network devices in the SRI, the present disclosure defines a lightweight IP of the SRI, the lightweight IP consists of three parts: an SRI-IP function, an S-IP function, and a G-IP function. The first network device is provided with the SRI-IP function, the G-IP function and an IP function at the same time, so that the first network device may first parse the SRI-IP packet via the SRI-IP function, obtain the payload of the SRI-IP packet, i.e., the SCTP/UDP packet sent by the fourth network device and/or the information added by the third network device (the third information), then internally transfer the payload of the parsed SRI-IP packet to the G-IP function through the SRI-IP function, and finally uses the G-IP function to construct the IP packet based on the payload of the SRI-IP packet and/or the information added by the first network device (the fourth information).

Step 703, the IP packet is sent to a second network device.

In some embodiments, for characteristics of the transmission between two network devices in the SRI, the present disclosure defines a lightweight IP of the SRI, the lightweight IP consists of three parts: an SRI-IP function, an S-IP function, and a G-IP function. The first network device is provided with the SRI-IP function, the G-IP function and an IP function at the same time, so the first network device may internally transfer the constructed IP packet to the IP function through the G-IP function, and send the IP packet to the second network device through the IP function.

According to the above embodiments, the first network device receives the SRI-IP packet sent by the third network device, where the SRI-IP packet is determined by the third network device based on the third information and/or the payload of the received S-IP packet sent by the fourth network device, and the third information is the information added by the third network device; determines the IP packet according to the fourth information and/or the payload of SRI-IP packet, where the fourth information is information added by the first network device; and sends the IP packet to the second network device. In this procedure, the first network device and the third network device perform the point-to-point transmission through the SRI, and the first network device receives the SRI-IP packet through the direct connection interface, i.e., the SRI, between the first network device and the third network device, which achieves near-zero IP layer overhead, helps to transmit more data or provide higher throughput under limited network bandwidth conditions. Meanwhile, the method avoids cross-layer transmission, and allows the data packet to be transmitted in a more direct and efficient manner within the network.

In order to clearly explain the data transmission procedure described in the above embodiments, an example will be provided for explanation.

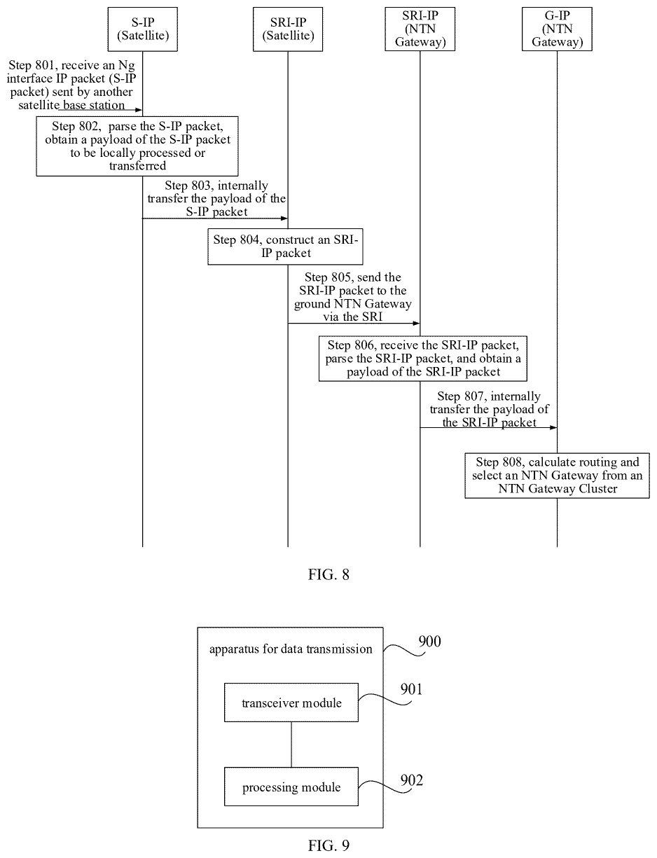

FIG. 8 is a flowchart of a satellite base station sending data and/or information to a ground NTN Gateway provided by an embodiment of the present disclosure.

As shown in FIG. 8, the procedure includes steps 801-808.

Step 801, an S-IP function on the satellite base station directly connected with the ground NTN Gateway receives an Ng interface IP packet (an S-IP packet) sent by another satellite base station.

The satellite base station directly connected with the ground NTN Gateway receives the data packet sent by another satellite base station through the S-IP.

Step 802, the S-IP function on the satellite base station directly connected with the ground NTN Gateway parses the S-IP packet, obtains a payload of the S-IP packet to be locally processed or transferred.

The S-IP function on the satellite base station directly connected with the ground NTN Gateway parses the S-IP packet to obtain the payload of the S-IP packet, i.e., an SCTP/UDP packet sent by the source satellite base station. If the S-IP packet is sent to the satellite base station, it will be processed locally and sent to a local SCTP or UDP function for processing. Otherwise, an SRI transmission is initiated.

Step 803, the payload of the S-IP packet is internally transferred.

The satellite base station directly connected with the ground NTN Gateway internally transfers the SCTP/UDP data packet and/or the satellite-added information (the third information) to the SRI-IP function through the S-IP function.

Step 804, the SRI-IP function on the satellite base station directly connected with the ground NTN Gateway constructs an SRI-IP packet.

For relevant explanations of SRI-IP packet, reference may be made to the description in the embodiments of the present disclosure, and will not be repeated here.

Step 805, the SRI-IP function on the satellite base station directly connected with the ground NTN Gateway sends the SRI-IP packet to the ground NTN Gateway via the SRI.

Step 806, an SRI-IP function on the ground NTN Gateway receives the SRI-IP packet, parses the SRI-IP packet, and obtains a payload of the SRI-IP packet.

The SRI-IP function on the ground NTN Gateway, after receiving the SRI-IP packet, parses the SRI-IP packet to obtain the payload of the SRI-IP packet, i.e., the SCTP/UDP packet and/or the third information.

Step 807, the payload of the SRI-IP packet is internally transferred.

The ground NTN Gateway internally transfers the payload of the SRI-IP packet and/or information (the fourth information) added by the NTN Gateway to a G-IP function through the SRI-IP function.

Step 808, the G-IP function on the ground NTN Gateway calculates routing and selects an NTN Gateway from an NTN Gateway Cluster.

The G-IP function on the ground NTN Gateway carries out the internal routing of the NTN Gateway (cluster), and constructs an IP packet based on the payload of the SRI-IP packet and/or the fourth information, and then sends the constructed IP packet to an IP function layer of a destination core network through ground general IP routing.

Therefore, for sending the information from the satellite base station to the ground core network, the IP packet is sent to the NTN Gateway through the satellite directly connected with the NTN Gateway, and routed to the target core network through the NTN Gateway. As a result, the SRI-IP may achieve nearly zero IP layer overhead, and may also realize the independence and isolation of routings between the space-based network and ground network, avoiding mutual influence on routing updates between the two. Furthermore, the SRI-IP defines a unified interface for the space-based and ground-based networks, enabling plug-and-play functionality. In addition, by fully delegating the processing of ground IP routing to the ground NTN Gateway, the load on the satellite-to-ground routing is reduced.

It can be seen from the data transmission method provided by the above embodiments of FIGS. 2, 3, 6 and 7 that the lightweight IP of the SRI is defined in the present disclosure for the transmission characteristics between two network devices (the first network device and the third network device) in the SRI. The protocol consists of three parts: the SRI-IP function, the S-IP function and the G-IP function. The first network device is provided with the SRI-IP function, the G-IP function and the IP function at the same time, and the third network device is provided with the SRI-IP function and the S-IP function at the same time.

When the second network device sends data to the third network device or the fourth network device, the first network device receives the IP packet sent by the second network device through the IP function, and internally transfers the IP packet to the G-IP function, parses the IP packet through the G-IP function, internally transfers the payload of the parsed IP packet and/or the information (the first information) added by the first network device to the SRI-IP function; constructs the SRI-IP packet through the SRI-IP function based on the payload of the IP packet and/or the first information, and sends the SRI-IP packet to the third network device through the direct connection interface (the SRI) between the first network device and the third network device. Accordingly, the third network device receives the SRI-IP packet sent by the first network device through the SRI-IP function, parses the SRI-IP packet, and in the case of non-local processing, internally transfers the payload of the SRI-IP packet parsed to the S-IP function; constructs the S-IP packet through the S-IP function based on the payload of the SRI-IP packet and/or the information (the second information) added by the third network device, and sends the S-IP packet to the fourth network device. Therefore, when the second network device sends data to the third network device or the fourth network device, the IP packet is sent to the third network device via the first network device, so that the IP packet may be processed on the third network device or routed to the fourth network device via the third network device.

When the fourth network device sends data to the second network device, the third network device receives the S-IP packet sent by the fourth network device through the S-IP function, parses the S-IP packet, and in the case of non-local processing, internally transfers the payload of the parsed S-IP packet to the SRI-IP function; and constructs the SRI-IP packet through the SRI-IP function based on the payload of the S-IP packet and/or the information (the third information) added by the third network device, and sends the SRI-IP packet to the first network device through the direct connection interface (the SRI) between the first network device and the third network device. Accordingly, the first network device receives the SRI-IP packet sent by the third network device through the SRI-IP function, parses the SRI-IP packet, and internally transfers the payload of the SRI-IP packet parsed to the G-IP function; constructs the IP packet through the G-IP function based on the payload of the SRI-IP packet and/or the information (the fourth information) added by the first network device, and sends the IP packet to the second network device. Therefore, when the fourth network device sends data to the second network device, the IP packet is sent to the first network device via the third network device, and then routed to the second network device via the first network device.

In the above procedures, the first network device and the third network device perform the point-to-point transmission through the SRI, and it is only required to encapsulate the received IP packet or S-IP packet once (encapsulated as the SRI-IP packet), which reduces the unnecessary addition of protocol layer header information and control information, reduces the data overhead, achieves nearly zero IP layer overhead, and helps to transmit more data or provide higher throughput when the network bandwidth is limited. At the same time, cross layer transmission is avoided, so that data packets may be transmitted in a more direct and efficient way in the network.

Corresponding to the method for data transmission provided by the embodiment related to FIG. 2, the present disclosure further provides an apparatus for data transmission. Since the apparatus for data transmission provided by embodiments of the present disclosure corresponds to the method for data transmission provided by the embodiment related to FIG. 2, implementations of the method for data transmission are also applicable to the apparatus for data transmission provided by embodiments of the present disclosure, and will not be described in detail here.

FIG. 9 is a structural schematic diagram of an apparatus for data transmission according to an embodiment of the present disclosure.

As shown in FIG. 9, the apparatus 900 for data transmission includes a transceiver module 901 and a processing module 902.

The transceiver module 901 is configured to receive an IP packet sent by a second network device.

The processing module 902 is configured to determine an SRI-IP packet based on first information and/or a payload of the IP packet, where the first information is information added by the first network device.

The transceiver module 901 is further configured to send the SRI-IP packet to a third network device.

In some embodiments, the first network device and the third network device perform a point-to-point data transmission via an SRI.

In some embodiments, the SRI-IP packet includes at least one of:
an SRI-IP packet not carrying an IP address;
an SRI-IP packet carrying an IP address of the SRI; or
an SRI-IP packet carrying address identification information of the SRI.

In some embodiments, the IP address of the SRI includes at least a destination IP address of the SRI-IP packet; and
the IP address of the SRI uses a short IP address definition method, or in response to the IP address of the SRI using a long IP address definition method, the SRI-IP packet carries a target segment of the IP address of the SRI which has a different value.

In some embodiments, the address identification information includes at least one of:
an identifier corresponding to an address pair of a source IP address and a destination IP address of the SRI-IP packet;
an identifier corresponding to a source IP address of the SRI-IP packet; or
an identifier corresponding to a destination IP address of the SRI-IP packet.

In some embodiments, the address identification information is indicated by a C-IP flow ID or a D-IP flow ID.

In some embodiments, the processing module 902 is further configured to:
parse the IP packet to obtain the payload of the IP packet; and
determine the SRI-IP packet based on the first information and/or the payload of the IP packet.

In some embodiments, the processing module 902 is further configured to perform at least one of:
in response to the SRI-IP packet not carrying the IP address, determining the SRI-IP packet based on the first information and/or the payload of the IP packet;
in response to the SRI-IP packet carrying the IP address of the SRI, using the first information and/or the payload of the IP packet as a payload of the SRI-IP packet, and determining the SRI-IP packet based on the payload of the SRI-IP packet and the IP address of the SRI;
in response to the SRI-IP packet carrying the address identification information of the SRI, using the first information and/or the payload of the IP packet as a payload of the SRI-IP packet, and determining the SRI-IP packet based on the payload of the SRI-IP packet and the address identification information of the SRI.

In some embodiments, the first information includes at least one of:
status information;
measurement information; or
data reception and transmission state information.

Corresponding to the method for data transmission provided by the embodiment related to FIG. 3, the present disclosure further provides an apparatus for data transmission. Since the apparatus for data transmission provided by embodiments of the present disclosure corresponds to the method for data transmission provided by the embodiment related to FIG. 3, implementations of the method for data transmission are also applicable to the apparatus for data transmission provided by embodiments of the present disclosure, and will not be described in detail here.

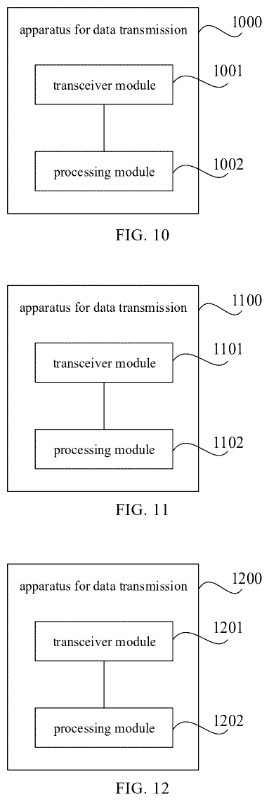

FIG. 10 is a structural schematic diagram of an apparatus for data transmission according to an embodiment of the present disclosure.

As shown in FIG. 10, the apparatus 1000 for data transmission includes a transceiver module 1001 and a processing module 1002.

The transceiver module 1001 is configured to receive an SRI-IP packet sent by a first network device; where the SRI-IP packet is determined by the first network device based on first information and/or a payload of a received IP packet sent by a second network device, and the first information is information added by the first network device.

The processing module 1002 is configured to determine an S-IP packet based on second information and/or a payload of the SRI-IP packet, where the second information is information added by the third network device.

The transceiver module 1001 is further configured to send the S-IP packet to a fourth network device.

In some embodiments, the first network device and the third network device perform a point-to-point data transmission via an SRI.

In some embodiments, the SRI-IP packet includes at least one of:
an SRI-IP packet not carrying an IP address;
an SRI-IP packet carrying an IP address of the SRI; or
an SRI-IP packet carrying address identification information of the SRI.

In some embodiments, the IP address of the SRI includes at least a destination IP address of the SRI-IP packet; and
the IP address of the SRI uses a short IP address definition method, or in response to the IP address of the SRI using a long IP address definition method, the SRI-IP packet carries a target segment of the IP address of the SRI which has a different value.

In some embodiments, the address identification information includes at least one of:
an identifier corresponding to an address pair of a source IP address and a destination IP address of the SRI-IP packet;
an identifier corresponding to a source IP address of the SRI-IP packet; or
an identifier corresponding to a destination IP address of the SRI-IP packet.

In some embodiments, the address identification information is indicated by a C-IP flow ID or a D-IP flow ID.

In some embodiments, the processing module 1002 is further configured to:
parse the SRI-IP packet to obtain the payload of the SRI-IP packet; and
determine the S-IP packet based on the second information and/or the payload of the SRI-IP packet.

The first information includes at least one of:
status information;
measurement information; or
data reception and transmission state information.

Corresponding to the method for data transmission provided by the embodiment related to FIG. 6, the present disclosure further provides an apparatus for data transmission. Since the apparatus for data transmission provided by embodiments of the present disclosure corresponds to the method for data transmission provided by the embodiment related to FIG. 6, implementations of the method for data transmission are also applicable to the apparatus for data transmission provided by embodiments of the present disclosure, and will not be described in detail here.

FIG. 11 is a structural schematic diagram of an apparatus for data transmission according to an embodiment of the present disclosure.

As shown in FIG. 11, the apparatus 1100 for data transmission includes a transceiver module 1101 and a processing module 1102.

The transceiver module 1101 is configured to receive an S-IP packet sent by a fourth network device.

The processing module 1102 is configured to determine an SRI-IP packet based on third information and/or a payload of the S-IP packet, where the third information is information added by the third network device.

The transceiver module 1101 is further configured to send the SRI-IP packet to a first network device.

In some embodiments, the first network device and the third network device perform a point-to-point data transmission via an SRI.

In some embodiments, the SRI-IP packet includes at least one of:
an SRI-IP packet not carrying an IP address;
an SRI-IP packet carrying an IP address of the SRI; or
an SRI-IP packet carrying address identification information of the SRI.

In some embodiments, the IP address of the SRI includes at least a destination IP address of the SRI-IP packet; and
the IP address of the SRI uses a short IP address definition method, or in response to the IP address of the SRI using a long IP address definition method, the SRI-IP packet carries a target segment of the IP address of the SRI which has a different value.

In some embodiments, the address identification information includes at least one of:
an identifier corresponding to an address pair of a source IP address and a destination IP address of the SRI-IP packet;
an identifier corresponding to a source IP address of the SRI-IP packet; or
an identifier corresponding to a destination IP address of the SRI-IP packet.

In some embodiments, the address identification information is indicated by a C-IP flow ID or a D-IP flow ID.

In some embodiments, the processing module 1102 is further configured to:
parse the S-IP packet to obtain the payload of the S-IP packet; and
determine the SRI-IP packet based on the third information and/or the payload of the S-IP packet.

In some embodiments, the processing module 1102 is further configured to perform at least one of:
in response to the SRI-IP packet not carrying the IP address of the SRI, determining the SRI-IP packet based on the third information and/or the payload of the S-IP packet;
in response to the SRI-IP packet carrying the IP address of the SRI, using the third information and/or the payload of the S-IP packet as a payload of the SRI-IP packet, and determining the SRI-IP packet based on the payload of the SRI-IP packet and the IP address of the SRI; or
in response to the SRI-IP packet carrying the address identification information of the SRI, using the third information and/or the payload of the S-IP packet as a payload of the SRI-IP packet, and determining the SRI-IP packet based on the payload of the SRI-IP packet and the address identification information of the SRI.

Corresponding to the method for data transmission provided by the embodiment related to FIG. 7, the present disclosure further provides an apparatus for data transmission. Since the apparatus for data transmission provided by embodiments of the present disclosure corresponds to the method for data transmission provided by the embodiment related to FIG. 7, implementations of the method for data transmission are also applicable to the apparatus for data transmission provided by embodiments of the present disclosure, and will not be described in detail here.

FIG. 12 is a structural schematic diagram of an apparatus for data transmission according to an embodiment of the present disclosure.

As shown in FIG. 12, the apparatus 1200 for data transmission includes a transceiver module 1201 and a processing module 1202.

The transceiver module 1201 is configured to receive an SRI-IP packet sent by a third network device, where the SRI-IP packet is determined by the third network device based on third information and/or a payload of a received S-IP packet sent by a fourth network device, and the third information is information added by the third network device.

The processing module 1201 is configured to determine an IP packet based on fourth information and/or a payload of the SRI-IP packet, where the fourth information is information added by the first network device.

The transceiver module 1201 is further configured to send the IP packet to a second network device.

In some embodiments, the first network device and the third network device perform a point-to-point data transmission via an SRI.

In some embodiments, the SRI-IP packet includes at least one of:
an SRI-IP packet not carrying an IP address;
an SRI-IP packet carrying an IP address of the SRI; or
an SRI-IP packet carrying address identification information of the SRI.

In some embodiments, the IP address of the SRI includes at least a destination IP address of the SRI-IP packet; and
the IP address of the SRI uses a short IP address definition method, or in response to the IP address of the SRI using a long IP address definition method, the SRI-IP packet carries a target segment of the IP address of the SRI which has a different value.

In some embodiment, the address identification information includes at least one of:
an identifier corresponding to an address pair of a source IP address and a destination IP address of the SRI-IP packet;
an identifier corresponding to a source IP address of the SRI-IP packet; or
an identifier corresponding to a destination IP address of the SRI-IP packet.

In some embodiment, the address identification information is indicated by a C-IP flow ID or a D-IP flow ID.

In some embodiment, the processing module 1202 is further configured to:
parse the SRI-IP packet to obtain the payload of the SRI-IP packet; and
determine the IP packet based on the fourth information and/or the payload of the SRI-IP packet.

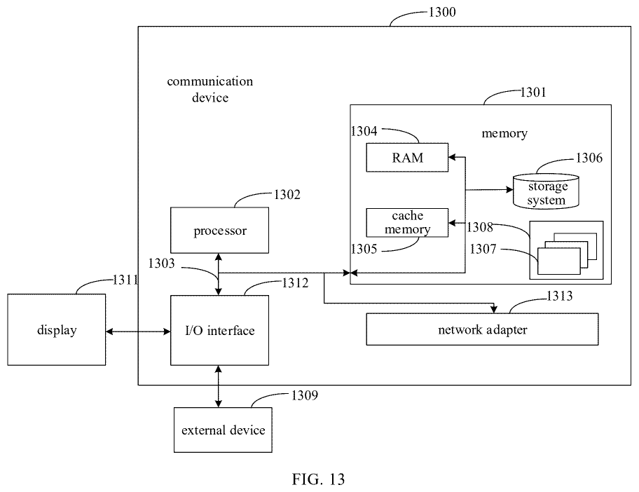

FIG. 13 is a block diagram of a communication device provided by an embodiment of the present disclosure. The communication device 1300 in the embodiment is intended to represent various forms of devices used for wireless communication, such as a terminal device, a network device, where the terminal may refer to a mobile terminal, a wearable device, and other similar communication devices. The components, their connections and relationships, and their functions illustrated here are only examples and are not intended to limit implementations of the present disclosure described and/or required here.

As shown in FIG. 13, the communication device 1300 includes:
a memory 1301, a processor 1302, and a bus 1303 connecting different components (including the memory 1301 and the processor 1302). The memory 1301 stores a computer program. When the processor 1302 executes the program, the method for data transmission applicable to a first network device or the method for data transmission applicable to a third network device in embodiments of the present disclosure is implemented.

The bus 1303 represents one or more of several types of bus structures, including a memory bus or memory controller, a peripheral bus, a graphics acceleration port, a processor, or a local bus using any of multiple bus structures. For example, these structures include but are not limited to an Industrial Standard Architecture (ISA) bus, a Micro channel Architecture (MAC) bus, an Enhanced ISA bus, a Video Electronics Standards Association (VESA) local bus, and a Peripheral Component Interconnect (PCI) bus.

The communication device 1300 typically includes multiple communication device readable media. These media may be any available media that is able to be accessed by the communication device 1300, including volatile and non-volatile media, removable and non-removable media.

The memory 1301 may also include a computer system readable medium in the form of volatile memory, such as random access memory (RAM) 1304 and/or cache memory 1305. The communication device 1300 may further include other removable/non removable, volatile/non-volatile computer system storage media. For example only, a storage system 1306 may be used to read from and write into a non-removable and non-volatile magnetic medium (not shown in FIG. 13, commonly referred to as a “hard disk drive”). Although not shown in FIG. 13, there may be provided with a disk drive for reading from and writing into a removable and non-volatile disk (such as a “floppy disk”) and an optical disk drive for reading from and writing into a removable and non-volatile optical disk (such as a CD ROM, a DVD ROM, or other optical media). In these cases, each driver may be connected to the bus 1303 via one or more data medium interfaces. The memory 1301 may include at least one program product having a set (e.g., at least one) of program modules configured to perform functions of embodiments of the present disclosure.

A program/utility 1308 having a set (at least one) of program modules 1307 may be stored in, for example, the memory 1301. The program module 1307 includes but not limited to an operating system, one or more application programs, other program modules, and program data, each of which or some of their combinations may include an implementation of a network environment. The program module 1307 typically performs functions and/or methods described in embodiments of the present disclosure.

The communication device 1300 may also communicate with one or more external devices 1309 (such as a keyboard, a pointing device, a display 1311, etc.), as well as with one or more devices that enable a user to interact with the communication device 1300, and/or with any device that enables the communication device 1300 to communicate with one or more other computing devices (such as a network card, a modem, etc.). The communication may be carried out via an input/output (I/O) interface 1312. Moreover, the communication device 1300 may also communicate with one or more networks (such as a local area network (LAN), a wide area networks (WAN), and/or a public network, such as the Internet) via a network adapter 1313. As shown in FIG. 13, the network adapter 1313 communicates with other modules of the communication device 1300 via the bus 1303. It should be understood that although not shown in the figure, other hardware and/or software modules may be used in conjunction with the communication device 1300, including but not limited to a microcode, a device driver, a redundant processing unit, an external disk drive array, an RAID system, a tape drive, and a data backup storage system.

The processor 1302 executes various functional applications and data processing by running the program stored in the memory 1301.

It should be noted that for implementations and principles of the communication device of the embodiment, reference may be made to the previous explanations of the method for data transmission applicable to the first network device or the method for data transmission applicable to the third network device in the embodiments of the present disclosure, and will not be repeated here.

In order to implement the above embodiments, the present disclosure also provides a communication system including a network device. The network device is configured to implement the method for data transmission applicable to the first network device or the method for data transmission applicable to the third network device provided in the aforementioned embodiments.

In order to implement the above embodiments, the present disclosure also provides a computer-readable storage medium, which stores computer-executable instructions. When the computer-executable instructions are executed by a processor, the instructions are used to implement the method for data transmission applicable to the first network device or the method for data transmission applicable to the third network device provided in the above embodiments.

In order to implement the above embodiments, the present disclosure also provides a computer program product including a computer program that, when executed by a processor, implements the method for data transmission applicable to the first network device or the method for data transmission applicable to the third network device provided in the above embodiments.

The collection, storage, use, processing, transmission, provision, and disclosure of user personal information involved in the present disclosure comply with relevant laws and regulations and do not violate public order and good customs.

It should be noted that personal information from users should be collected for legitimate and reasonable purposes, and should not be shared or sold outside of these legitimate uses. In addition, such collection/sharing should be carried out after receiving the user's informed consent, including but not limited to notifying the user to read the user agreement/user notification and sign an agreement/authorization that includes authorization of relevant user information before using the function. In addition, any necessary steps must be taken to safeguard and guarantee access to such personal information data, and to ensure that others who have the right to access personal information data comply with their privacy policies and procedures.

The present disclosure is intended to provide implementations for the user to selectively prevent the use or access of personal information data. The present disclosure is intended to provide hardware and/or software to prevent or block access to such personal information data. Once the personal information data is no longer needed, limiting data collection and deleting data may minimize risks. In addition, when applicable, personal identifiers should be removed from such personal information to protect the privacy of the user.

In the aforementioned embodiments, the reference terms “one embodiment”, “some embodiments”, “examples”, “specific examples”, or “some examples” refer to the specific features, structures, materials, or characteristics described in conjunction with the embodiments or examples included in at least one embodiment or example of the present disclosure. In the specification, the schematic expressions of the above terms do not necessarily refer to the same embodiments or examples. Moreover, the specific features, structures, materials, or characteristics described may be combined in any one or more embodiments or examples in an appropriate manner. In addition, in the absence of contradiction, a person skilled in the art may combine different embodiments or examples described in the specification, as well as features of different embodiments or examples.

In addition, the terms “first” and “second” are only used for descriptive purposes and cannot be understood as indicating or implying relative importance or implying the number of technical features indicated. Therefore, the features that are limited with “first” or “second” may explicitly or implicitly include at least one of these features. In the present disclosure, the meaning of “multiple” refers to at least two, such as two, three, etc., unless otherwise specified.

It can be understood that any procedure or method described in a flowchart or otherwise described may represent that one or more modules, fragments, or portions of codes of executable instructions for implementing one or more steps of a customized logic function or procedure are included, and the scope of the preferred embodiments of the present disclosure includes additional implementations, in which functions involved may not be performed in the order shown or discussed, but may be performed in a substantially simultaneous manner or in a reverse order based on the functions. This should be understood by those skilled in the art to which embodiments of the present disclosure belong.

Logic and/or steps represented in a flowchart or otherwise described here, such as a sequential list of executable instructions used to implement logical functions, may be specifically implemented in any computer-readable medium for use by an instruction execution system, apparatus, or device (such as a computer-based system, a system including a processor, or other systems that may take instructions from an instruction execution system, apparatus, or device and may execute the instructions), or used in conjunction with the instruction execution system, apparatus, or device. For the purpose of the specification, a “computer-readable medium” may be any device that may contain, store, communicate, transfer, or transmit a program for use in the instruction execution system, apparatus, or device, or may be used in combination with such instruction execution system, apparatus, or device. More specific examples of the computer-readable medium (as an non exhaustive list) include an electrical connector (an electronic device) with one or more wiring, a portable computer disk cartridge (a magnetic device), a random access memory (RAM), a read-only memory (ROM), an erasable and editable read-only memory (EPROM or a flash memory), a fiber optic device, and a portable optical disc read-only memory (CDROM). In addition, the computer-readable medium may even be paper or other suitable media on which the program may be printed, as the program may be obtained electronically, for example, by optical scanning of paper or other media, followed by editing, interpretation, or necessary processing in other suitable ways, and then may be stored in a computer memory.

It should be understood that the various parts of the present disclosure may be implemented using hardware, software, firmware, or a combination thereof. In the above embodiments, multiple steps or methods may be implemented using software or firmware stored in the memory and executed by a suitable instruction execution system. If implemented in hardware, as in another implementation, any one or a combination of the following techniques known in the art may be used: discrete logic circuits with logic gate circuits for implementing logic functions on data signals, application specific integrated circuits with suitable combinational logic gate circuits, programmable gate arrays (PGAs), field programmable gate arrays (FPGAs), etc.

A person skilled in the art may understand that implementation of all or part of the steps carried by the methods of the above embodiments may be completed by instructing relevant hardware through a program. The program may be stored in a computer-readable storage medium, and when executed, it includes one or a combination of the steps of the method embodiments.

In addition, various function units in embodiments of the present disclosure may be integrated into one processing module, or the function units may exist separately physically, or two or more function units may be integrated into one module. The integrated module mentioned above may be implemented in the form of hardware or software function module. If the integrated module is implemented in the form of software functional module and sold or used as an independent product, the integrated module may also be stored in a computer-readable storage medium.

The storage medium mentioned above may be a read-only memory, a magnetic disk or an optical disk, etc. Although the embodiments of the present disclosure have been shown and described above, it is understandable that the above embodiments are examples and should not be construed as limiting the present disclosure. A person skilled in the art may make changes, modifications, substitutions, and variations to the above embodiments within the scope of the present disclosure.

What is claimed is:

1. A method for data transmission, performed by a communication system comprising a first network device, the method comprising:
receiving, by the first network device, an internet protocol (IP) packet sent by a second network device;
determining, by the first network device, a satellite radio interface-IP (SRI-IP) packet based on at least one of first information or a payload of the IP packet, wherein the first information is information added by the first network device; and
sending, by the first network device, the SRI-IP packet to a third network device.

2. The method according to claim 1, wherein the first network device and the third network device perform a point-to-point data transmission via an SRI.

3. The method according to claim 2, wherein the SRI-IP packet comprises at least one of:
an SRI-IP packet not carrying an IP address;
an SRI-IP packet carrying an IP address of the SRI; or
an SRI-IP packet carrying address identification information of the SRI.

4. The method according to claim 3, wherein the IP address of the SRI comprises at least a destination IP address of the SRI-IP packet; and
the IP address of the SRI uses a short IP address definition method, or in response to the IP address of the SRI using a long IP address definition method, the SRI-IP packet carries a target segment of the IP address of the SRI which has a different value.

5. The method according to claim 3, wherein the address identification information comprises at least one of:
an identifier corresponding to an address pair of a source IP address and a destination IP address of the SRI-IP packet;
an identifier corresponding to a source IP address of the SRI-IP packet; or
an identifier corresponding to a destination IP address of the SRI-IP packet.

6. The method according to claim 3, wherein the address identification information is indicated by a compressed IP flow identifier (C-IP flow ID) or a derived IP flow identifier (D-IP flow ID).

7. The method according to claim 3, wherein determining, by the first network device, the SRI-IP packet based on at least one of the first information or the payload of the IP packet comprises:
parsing, by the first network device, the IP packet to obtain the payload of the IP packet; and
determining, by the first network device, the SRI-IP packet based on at least one of the first information or the payload of the IP packet.

8. The method according to claim 7, wherein determining, by the first network device, the SRI-IP packet based on at least one of the first information or the payload of the IP packet comprises at least one of:
in response to the SRI-IP packet not carrying the IP address, determining the SRI-IP packet based on at least one of the first information or the payload of the IP packet;
in response to the SRI-IP packet carrying the IP address of the SRI, using at least one of the first information or the payload of the IP packet as a payload of the SRI-IP packet, and determining the SRI-IP packet based on the payload of the SRI-IP packet and the IP address of the SRI; or
in response to the SRI-IP packet carrying the address identification information of the SRI, using at least one of the first information or the payload of the IP packet as a payload of the SRI-IP packet, and determining the SRI-IP packet based on the payload of the SRI-IP packet and the address identification information of the SRI.

9. The method according to claim 1, wherein the first information comprises at least one of:
status information;
measurement information; or
data reception and transmission state information.

10. The method according to claim 1, wherein the communication system further comprises the third network device, and the method further comprises:
receiving, by the third network device, the SRI-IP packet sent by the first network device;
determining, by the third network device, a satellite-internet protocol (S-IP) packet based on at least one of second information or a payload of the SRI-IP packet, wherein the second information is information added by the third network device; and
sending, by the third network device, the S-IP packet to a fourth network device.

11. The method according to claim 10, wherein determining, by the third network device, the S-IP packet based on at least one of the second information or the SRI-IP packet comprises:
parsing, by the third network device, the SRI-IP packet to obtain the payload of the SRI-IP packet; and
determining, by the third network device, the S-IP packet based on at least one of the second information or the payload of the SRI-IP packet.

12. A method for data transmission, performed by a communication system comprising a third network device, the method comprising:
receiving, by the third network device, a satellite-internet protocol (S-IP) packet sent by a fourth network device;
determining, by the third network device, a satellite radio interface-internet protocol (SRI-IP) packet based on at least one of third information or a payload of the S-IP packet, wherein the third information is information added by the third network device; and
sending, by the third network device, the SRI-IP packet to a first network device.

13. The method according to claim 12, wherein the first network device and the third network device perform a point-to-point data transmission via an SRI.

14. The method according to claim 13, wherein the SRI-IP packet comprises at least one of:
an SRI-IP packet not carrying an IP address;
an SRI-IP packet carrying an IP address of the SRI; or
an SRI-IP packet carrying address identification information of the SRI.

15. The method according to claim 14, wherein the IP address of the SRI comprises at least a destination IP address of the SRI-IP packet, and the IP address of the SRI uses a short IP address definition method, or in response to the IP address of the SRI using a long IP address definition method, the SRI-IP packet carries a target segment of the IP address of the SRI which has a different value; or
wherein the address identification information comprises at least one of an identifier corresponding to an address pair of a source IP address and a destination IP address of the SRI-IP packet, an identifier corresponding to a source IP address of the SRI-IP packet, or an identifier corresponding to a destination IP address of the SRI-IP packet; or
wherein the address identification information is indicated by a compressed IP flow identifier (C-IP flow ID) or a derived IP flow identifier (D-IP flow ID).

16. The method according to claim 14, wherein determining, by the third network device, the SRI-IP packet based on at least one of the third information or the payload of the S-IP packet comprises:
parsing, by the third network device, the S-IP packet to obtain the payload of the S-IP packet; and
determining, by the third network device, the SRI-IP packet based on at least one of the third information or the payload of the S-IP packet.

17. The method according to claim 16, wherein determining, by the third network device, the SRI-IP packet based on at least one of the third information or the payload of the S-IP packet comprises at least one of:
in response to the SRI-IP packet not carrying the IP address of the SRI, determining the SRI-IP packet based on at least one of the third information or the payload of the S-IP packet;
in response to the SRI-IP packet carrying the IP address of the SRI, using at least one of the third information or the payload of the S-IP packet as a payload of the SRI-IP packet, and determining the SRI-IP packet based on the payload of the SRI-IP packet and the IP address of the SRI; or
in response to the SRI-IP packet carrying the address identification information of the SRI, using at least one of the third information or the payload of the S-IP packet as a payload of the SRI-IP packet, and determining the SRI-IP packet based on the payload of the SRI-IP packet and the address identification information of the SRI.

18. The method according to claim 12, wherein the communication system further comprises the first network device, and the method further comprises:
receiving, by the first network device, the SRI-IP packet sent by the third network device;
determining, by the first network device, an IP packet based on at least one of fourth information or a payload of the SRI-IP packet, wherein the fourth information is information added by the first network device; and
sending, by the first network device, the IP packet to a second network device.

19. The method according to claim 18, wherein determining, by the first network device, the IP packet based on at least one of the fourth information or the payload of the SRI-IP packet comprises:
parsing, by the first network device, the SRI-IP packet to obtain the payload of the SRI-IP packet; and
determining, by the first network device, the IP packet based on at least one of the fourth information or the payload of the SRI-IP packet.

20. A communication system, comprising a first network device,
wherein the first network device is configured to: receive an internet protocol (IP) packet sent by a second network device; determine a satellite radio interface-IP (SRI-IP) packet based on at least one of first information or a payload of the IP packet, wherein the first information is information added by the first network device; and send the SRI-IP packet to a third network device.
